(19) United States
(12) Patent Application Publication
(10) Pub. No.: US 2013/0076003 A1
(43) Pub. Date: Mar. 28, 2013

(54) WHEELCHAIR, WHEELCHAIR SUPPORT AND TRAVEL PILLOW

(71) Applicants: Karen E. Lanci, Armonk, NY (US); Anna Wei Kronthal, Harrison, NY (US)

(72) Inventors: Karen E. Lanci, Armonk, NY (US); Anna Wei Kronthal, Harrison, NY (US)

(21) Appl. No.: 13/239,668

(22) Filed: Sep. 22, 2011

(51) Int. Cl. A61G 5/10; A47G 9/10

(52) U.S. Cl. 280/304.1; 5/655.3

(57) ABSTRACT

A wheelchair assembly featuring an adjustable support comprised of two inflatable pillows that are housed in a single cover or separate, discrete covers which are releasably adjoined to each other. The support is releasably attached by adjustable straps to wheelchair armrests and is adapted to provide enhanced support for the user's body and remain stationary when the user's body is rested thereon. The invention is also directed to a wheelchair support comprising two inflatable pillows housed in a single cover or two separate covers. The invention is further directed to a highly adjustable travel pillow comprised of two inflatable cushions that are preferably housed in separate, discrete covers which are releasably adjoined to each other. The back of the travel pillow cover has an anti-skid material to maintain its position.

### FIELD OF THE INVENTION

This invention relates generally to supportive cushions and more specifically to wheelchair support cushions, and travel pillows.

### BACKGROUND OF THE INVENTION

A wheelchair user often requires a cushioned support in order to rest their head, neck, and upper back regions while sitting in the wheelchair. However, many wheelchair designs do not provide adequate support for a user's head, neck, and upper back. For instance, many wheelchair designs have back portions that terminate at the middle portion of the user's back. Head supports have been developed which attach to wheelchairs to provide additional head, neck and upper back support. However, these supports are usually difficult to attach to the wheelchair. Furthermore, known attachable wheelchair head supports are not sufficiently adjustable and may require permanent or semi-permanent means for attachment to the wheelchair.

Furthermore, it is desired to have a travel pillow that is easily adjustable, compact, and provides optimal support for the user.

Accordingly, it is an object of the present invention to provide an improved wheelchair having a support that is releasably attached to the wheelchair armrest and is highly adjustable.

Another object of the present invention is to provide an improved support that is adapted to be releasably attached to a wheelchair.

Yet another object of the present invention is to provide a compact travel pillow that is highly adjustable and provides optimal comfort.

### SUMMARY OF THE INVENTION

The foregoing objects are met by the present invention directed to an improved wheelchair assembly which features an adjustable support. The support is comprised of two inflatable pillows which are housed in a single cover. Alternatively, the support may be comprised of two inflatable pillows that are housed in separate, discrete covers which are releasably adjoined to each other. The support includes adjustable straps which extend from the pillow assembly through an opening beneath each of the wheelchair armrests. The adjustable straps have releasable securement means to easily attach or detach the support to the wheelchair armrest. The straps are adapted to be adjusted to a length that prohibits further movement of the user's body past a desired position when the user rests their body on the pillow. The back of the support has an anti-skid material which further maintains the position of the support on the wheelchair.

The support is adapted to be easily attached to the wheelchair by the user in a secure manner. The level of support is also adapted to be easily modified by the user. The pillow covers have releasable sealing means which enable the user to open the pillow covers and change the positioning of the pillows or change the amount of air pressure in the pillows as needed. The invention is also directed to the support by itself which serves as a releasably attachable accessory for a wheelchair.

The invention is also directed to a travel pillow. The travel pillow is comprised of two inflatable cushions that are housed in separate, discrete covers which are releasably adjoined to each other by snap fasteners or other means well known in the art. The covers for the travel pillow include releasable sealing means to allow the user to modify the air pressure of each pillow. The back of the travel pillow has an anti-skid material which is adapted to maintain the position of the pillow against a surface when light pressure is placed upon it by the user's body.

The travel pillow is compact and highly adjustable and is particularly effective for use on an automobile, airplane, train, or bus seat. The pillow is adapted so the user can rest their head on one cushion while placing the other cushion on a lower portion of their body, such as their torso or leg region. Furthermore, the cushions can stack on top of each other when adjoined so that a thick pillow is formed for enhanced support. The cushions are adapted to be easily wedged in a corner between the seat and a wall to provide a customized, tailored level of comfort in normally uncomfortable situations. The cushions can also be twisted with respect to each other when adjoined to further customize the positioning of the pillow and support provided thereby.

The releasable adjoining means enable the user to easily disconnect the cushions from each other so that each cushion can be used apart from each other in numerous different configurations. For instance, the separated cushions may be used for lumbar support, a lap rest, head support, leg support, foot rest, elbow rest, etc.

In another embodiment, the travel pillow comprises two inflatable cushions housed in a single cover with releasable sealing means.

### DESCRIPTION OF THE DRAWINGS

The above and other objects, features and advantages of the present invention will become apparent from the following description of preferred but, nonetheless, illustrative embodiments of the invention, taken in conjunction with the accompanying drawings, wherein

FIG. 1 provides a perspective view of the wheelchair having a support comprised of a pair of laterally spaced inflatable cushions housed in a cover.

FIG. 2 provides a perspective view of the wheelchair having a support comprised of a pair of laterally spaced inflatable cushions that are housed in separate, discrete covers and have releasable adjoining means.

FIG. 3 provides a back elevational view of the wheelchair having a support comprised of a pair of laterally spaced inflatable cushions housed in a cover.

FIG. 4 provides a perspective view of the back of a releasably attachable wheelchair support comprised of a pair of laterally spaced inflatable cushions housed in a cover.

FIG. 5 provides a perspective view of the back of a releasably attachable wheelchair support comprised of a pair of laterally spaced inflatable cushions that are housed in separate, discrete covers and have releasable adjoining means.

FIG. 6 provides a perspective view of the back of a travel pillow comprised of a pair of laterally spaced inflatable cushions that are housed in separate, discrete covers and have releasable adjoining means

FIG. 6a provides a perspective view of a travel pillow comprised of a pair of laterally spaced inflatable cushions that are housed in separate, discrete covers and have releasable adjoining means wherein the laterally spaced inflatable cushions are pivoted with respect to each other.

FIG. 6b provides a perspective view of a travel pillow comprised of a pair of laterally spaced inflatable cushions that are housed in separate, discrete covers and have releasable adjoining means wherein the laterally spaced inflatable cushions are stacked on top of each other while adjoined to form a thick pillow.

### DETAILED DESCRIPTION OF THE PREFERRED EMBODIMENTS

With particular reference to the drawings, the present invention is directed to an improved wheelchair assembly 2 having an adjustable support 4. The wheelchair assembly 2 features a frame 6, wheels 8, and a seat 10. The wheelchair seat 10 has a bottom 14 and a back 16 for supporting the user. The wheelchair also includes an armrest 12 on each side of the wheelchair. Each armrest is generally comprised of two vertical support poles 11 and a horizontal portion 13 which provides the resting surface for the user's arms. The vertical support poles 11 and horizontal portion 13 define an opening 9 between the seat bottom 14 and the armrest 12. The wheelchair may also have one or more lower rails 17.

In order to provide enhanced comfort and support for the user, the wheelchair 2 includes an adjustable support 4. The adjustable support 4 is comprised of cushioning 20 and releasable attachment means 21 which are adapted to attach the cushioning 20 to the armrests 12 of the wheelchair. The releasable attachment means 21 secures the cushioning 20 to the wheelchair solely by attachment to the armrests 12. The releasable attachment of the support 4 solely to the armrests 12 provides a secure, simple, and economical means for releasably attaching the support to the wheelchair. The releasable attachment means 21 is also adapted to be secured to the one or more lower rails 17 of the wheelchair or other suitable structure on the wheelchair.

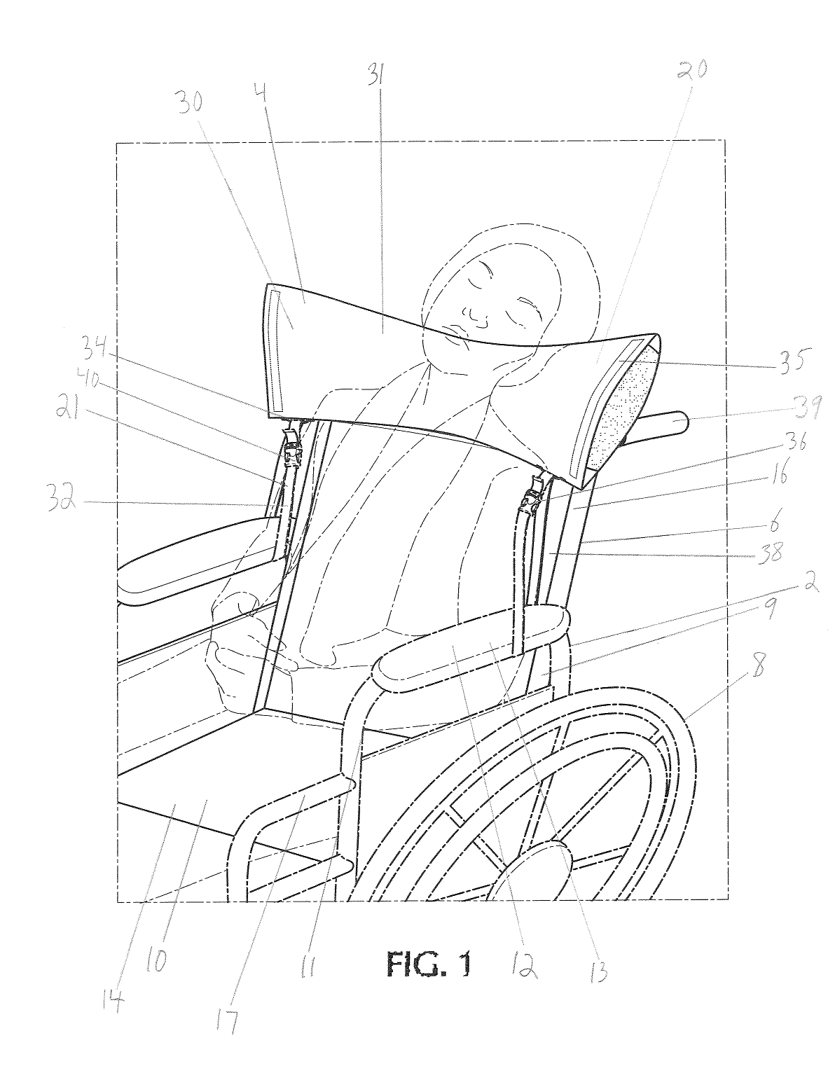

The cushioning 20 is preferably comprised of a plurality of inflatable cushions fabricated out of materials well known in the art, including plastic and fabric. In a preferred embodiment shown in FIG. 1, the cushioning 20 comprises a pair of laterally spaced inflatable cushions 30 that are housed in a cover 31. As shown in FIG. 1, the cover 31 preferably is greater in width than height and may be generally rectangular in shape. The cover is adapted to maintain the inflatable cushions 30 in a laterally spaced orientation. The cover 31 is preferably fabricated of a comfortable material known in the art including natural textiles such as cotton, velour, etc. or a synthetic material. The cover 31 protects the cushioning from being soiled and provides increased comfort for the cushioning.

The cover has means 35 for releasably sealing the inflatable cushions 30 to allow the user to open the cover and adjust the cushioning therein. For instance, the user can open the releasable sealing means and inflate or deflate the cushioning or change its positioning inside the cover to precisely alter the support provided by the cushioning. The releasable sealing means may be hook and loop fasteners, snap fasteners, zippers or other means well known in the art. The valves on the cushioning may be any motorized or mechanical valve known in the art including nipple valves.

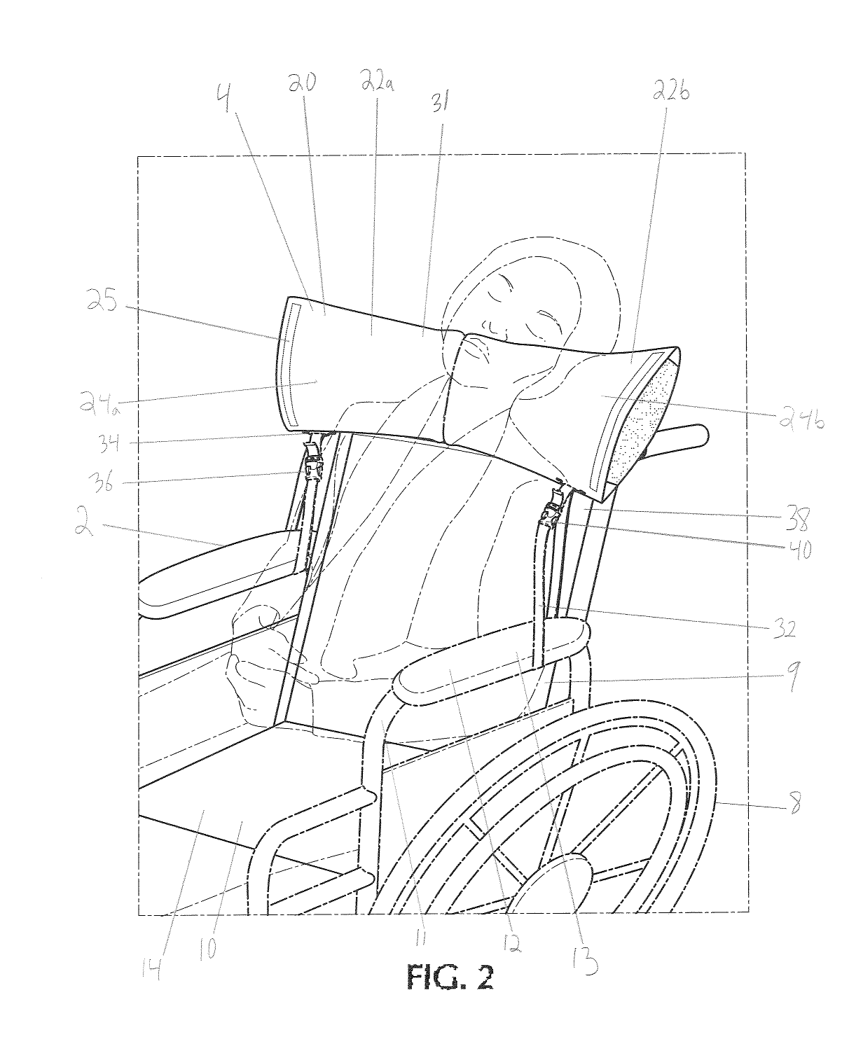

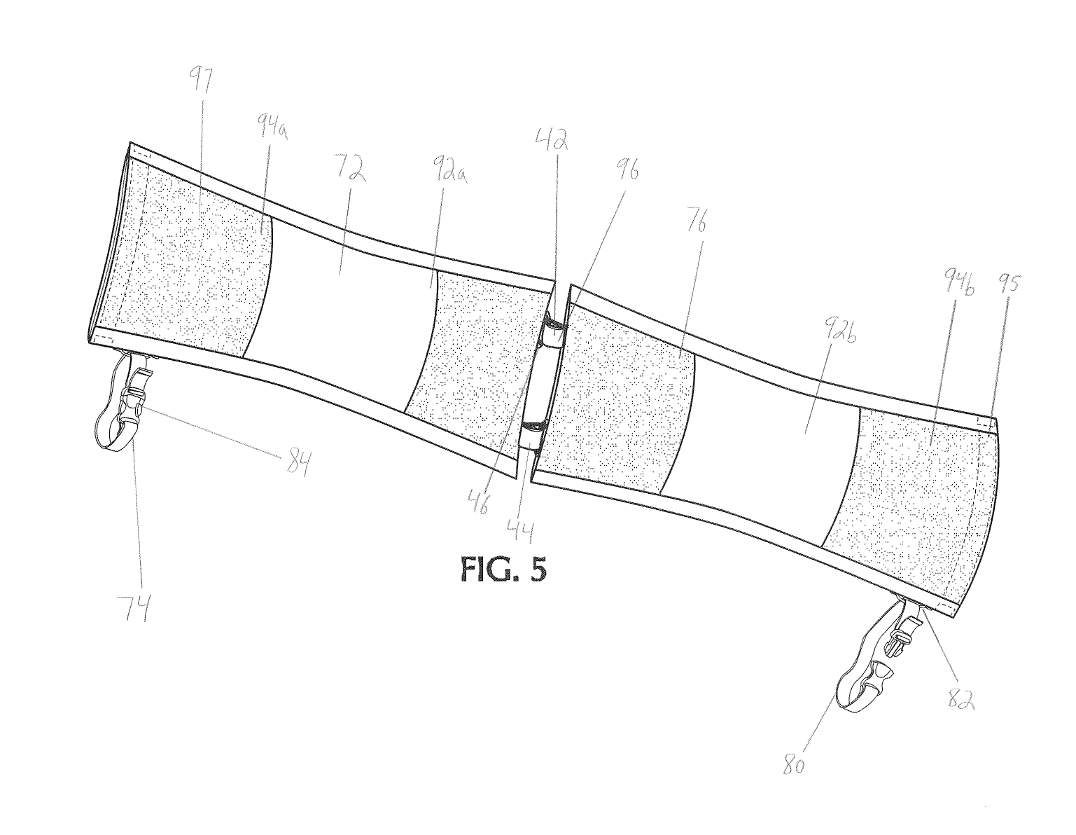

In another embodiment shown in FIG. 2, the cushioning 20 for the support 4 is comprised of a pair of inflatable cushions 22a, 22b, which are laterally spaced and are preferably housed in separate, discrete covers 24a, 24b having releasable sealing means 25. The covers 24a, 24b have adjoining means 42 to connect the cushions to each other in an adjacent relationship. For instance, as shown in FIG. 5, the adjoining means 42 may be a series of snap fasteners 44 secured to tabs 45 which are adapted to receive a loop 46 on an adjacent pillow. The snap fasteners 44 are matingly attached to each other in order to secure the loop 46 in the fastener and connect the pillows to each other. The adjoining means 42 may be any other releasable attachment method known in the art including hook and loop fasteners, ties, zippers, buttons, etc. When the snap fasteners 44 are engaged, the cushions 22a, 22b are firmly connected to each other but can be easily released from each other as needed by disengaging the snap fasteners. The adjoining means 42 are preferably adjustable so that the user can easily change the distance between the pair of inflatable cushions 22(a), 22(b). For instance, the snap fasteners may have a plurality of offset snap fasteners along the tabs 45 to allow the distance between the cushions 22(a), 22(b) to be adjusted. Alternatively, the adjoining means may have a slide buckle or other means known in the art which allow the length of the adjoining means to be adjusted.

While the cushioning in the embodiment shown in FIG. 2 is shown having separate covers 24a, 24b, the cushioning may comprise separate cushions without any covers thereon. In the embodiment without covers, the adjoining means may be attached directly to the bodies of the cushions and anti-skid material may be laminated directly on the back of cushions.

For improved comfort, the support 4 may include a top cushion which overlies the cushioning 20. The top cushion may be fabricated out of gel, beads, water, buckwheat, kapok, cotton, foam, fluid, gases, plush material, batting, feathers, any combination thereof, or any similar other cushioning well known in the art. In embodiments with one or more covers, 24a, 24b, 31, the top cushion may be positioned inside the covers. As an example, the covers 24a, 24b, 31 may include a releasably-sealed pocket for receiving the top cushion. The top cushion is adapted so that the portion of the user's body contacting the support will rest against the top cushion for enhanced comfort.

As shown in FIGS. 1-2, the releasable attachment means which secure the cushioning to the armrests 12 of the wheelchair are preferably straps 32. In embodiments where the cushioning includes one or more covers, as shown in FIGS. 1-2, the attachment means may be attached directly to the cover(s). The straps 32 may be integrally formed with the cushioning 20 or cover(s) 24a, 24b, 31 or may be connected by means well known in the art including fasteners, stitching, etc. For instance, in FIGS. 1-2, the cushioning 20 has a cover 24a, 24b, 31 with a pair of loops 34 integral to the cover. While the loops are shown on the bottom of the cover in FIGS. 1-2, the loops may be in any desired orientation and in any number on the cushioning or cover(s). Examples of orientations for the loops on the cushioning or cover include configuring the loops solely on the top of the cushioning or cover, on the top and bottom of the cover, and either on one or both lateral sides of the cover. The straps 32 extend from the loops 34 through the opening 9 between the armrest 12 and seat in order to attach the support 4 to the remainder of the wheelchair assembly 2. In embodiments where the cushioning is not in a cover, the straps 32 may be attached directly to the cushioning 20. The straps 32 preferably have an anti-skid material on their surface which is adapted to contact a portion of the armrest 12 in order to maintain the positioning of the strap.

The straps 32 preferably have adjusting means 36 which allows the length of the straps to be easily modified by the user. The adjustment means 36 may comprise a slide buckle 40 as shown in FIGS. 1-2, or may comprise other means well known in the art. The adjustment means 36 permit the user to place the cushioning 20 in a large variety of orientations with respect to the armrests 12. For instance, it is contemplated that the cushioning will often be placed alongside the top portion of the front-facing surface 38 of the back of the seat so that the cushioning effectively lengthens the back of the seat and provides a contoured surface for the user to rest their head. The adjustability of the cushioning's position as well as the conforming nature of the fluid-filled cushioning allow the user to recline their head on the cushioning in numerous orientations and positions. The adjustable straps 32 are adapted so that when the user's body is rested on the cushioning, the strap prohibits further backward movement and securely supports the user's head in a fixed position. The cushioning 20 may be inflated or deflated as necessary to further adjust the support.

The support 4 is adapted so that the user may position the support in their preferred orientation and then rest their body on the support to secure the support in place. If additional slack is needed from the straps 32 for effective positioning of the support, the user can easily lengthen the straps. Alternatively, if the straps 32 are too long and are failing to properly support the user, the user can easily shorten the straps.

While the primary intended purpose of the support 4 is for resting the user's upper back, neck and head regions, the support may also be used for the user's lower back, middle back, and extremities. For instance, in the embodiment shown in FIG. 2, the pair of inflatable pillows 22a, 22b may be used in a connected form along the user's side, lap, or legs. A single pillow may also support the head region of the user while the other pillow supports a lower portion of the user's body. The pillows are adapted to be easily disconnected from each other to enable the user to utilize the separated pillows by themselves in a large variety of different orientations.

The straps 32 have securement means which serve to releasably secure the attachment means 21 to the armrests 12 of the wheelchair. In the embodiment shown in FIGS. 1-2 the securement means comprises a buckle and clasp system. Alternatively, the securement means may be snap fasteners, hook and loop fasteners, or other releasable attachment means well known in the art.

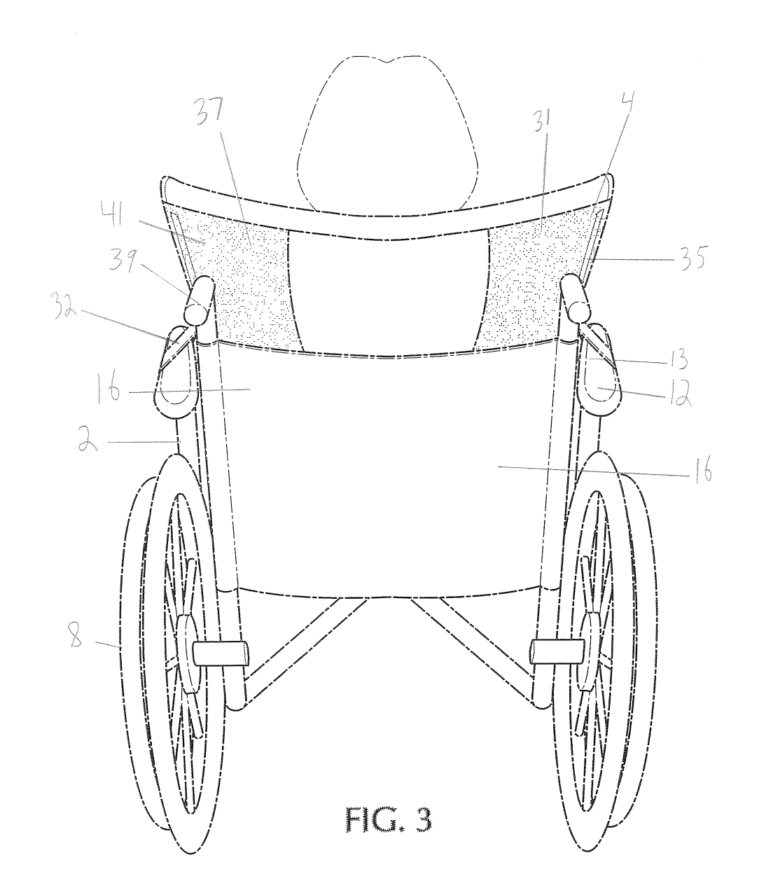

As shown in FIG. 3, the support 4 has an anti-skid material 37 on the back side 41 of the cushioning 20 or cover 24a, 24b, 31 which is in contact with a portion of the back 16 of the seat. When the user places light pressure on the cushioning 20, the anti-skid material 37 is adapted to maintain the position of the cushioning on the wheelchair back 16 and the wheelchair handlebars 39 and resist further movement. The anti-skid material may be a synthetic or natural material known in the art such as synthetic leather, or synthetic pig skin.

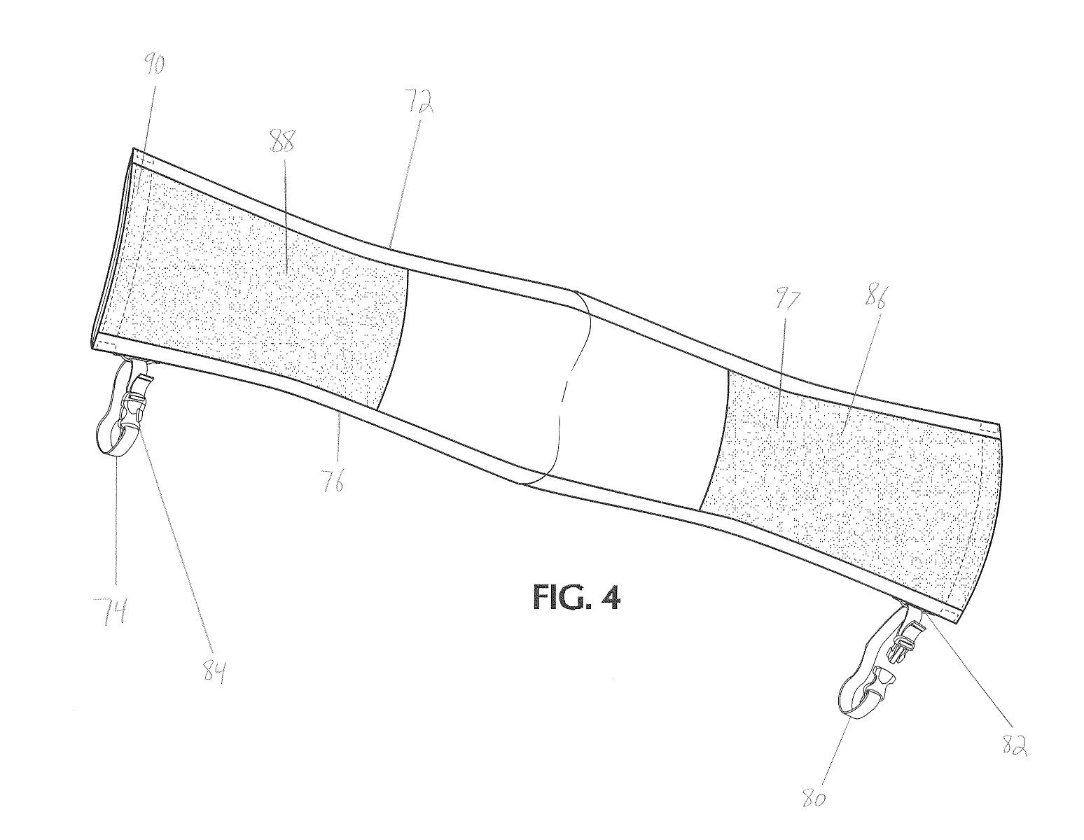

Another aspect of the invention is directed to the wheelchair support 76 shown in FIGS. 4-5 as described above and incorporated by reference herein. The adjustable wheelchair support 76 is comprised of cushioning 72 and releasable attachment means 74 which are adapted to attach the cushioning 72 to the armrests of a wheelchair. The releasable attachment means 74 secures the cushioning 72 to a wheelchair solely by attachment to the armrests 12.

As shown in FIGS. 4-5 the releasable attachment means 74 preferably comprise adjustable straps 80 which extend from loops 82 on the wheelchair support 76 through an opening between the armrest and seat bottom of a wheelchair. The straps 80 have releasable securement means 84 such as a buckle and clasp fastener as shown in FIGS. 4-5. The adjustable straps 80 are adapted so that when the user's body is rested on the cushioning 72, the straps prohibit further backward movement and securely support the user's head in a fixed position.

In a preferred embodiment shown in FIG. 4, the cushioning 72 comprises a pair of laterally spaced inflatable cushions 86 that are housed in a cover 88. The cover has means 90 for releasably sealing the inflatable cushions 86 to allow the user to open the cover and adjust the cushioning therein. In another embodiment shown in FIG. 5, the cushioning 72 for the support 76 is comprised of a pair of inflatable cushions 92a, 92b, which are laterally spaced and are preferably housed in separate, discrete covers 94a, 94b having releasable sealing means 95. The covers 94a, 94b have adjoining means 96 to connect the cushions to each other in an adjacent relationship. While the cushioning 72 in the embodiment shown in FIG. 5 is shown having separate covers 94a, 94b, the cushioning may comprise separate cushions without any covers thereon. In the embodiment without covers, the adjoining means 96 may be attached directly to the bodies of the pillows.

The support 76 may also include a top cushion which overlies the cushioning 72 so that the portion of the user's body contacting the support will rest against the top cushion for enhanced comfort.

The support 76 has an anti-skid material 97 on the back side of the cushioning 72 or covers 88, 94a, 94b which contacts a portion of the back 16 of the seat so that when the user places light pressure on the support 76, the anti-skid material 97 is adapted to maintain the position of the support on the wheelchair back.

The support 76 serves as an accessory for a wheelchair and can be releasably attached to the armrests of any wheelchair having an armrest with a suitable opening to offer enhanced support for the user. The support 76 is adapted to be attached to a wheelchair without damaging the wheelchair or requiring any permanent, or semi-permanent modification to the wheelchair assembly. The releasably attachable support 76 is a secure, simple, and economical means for providing an adjustable support for a wheelchair.

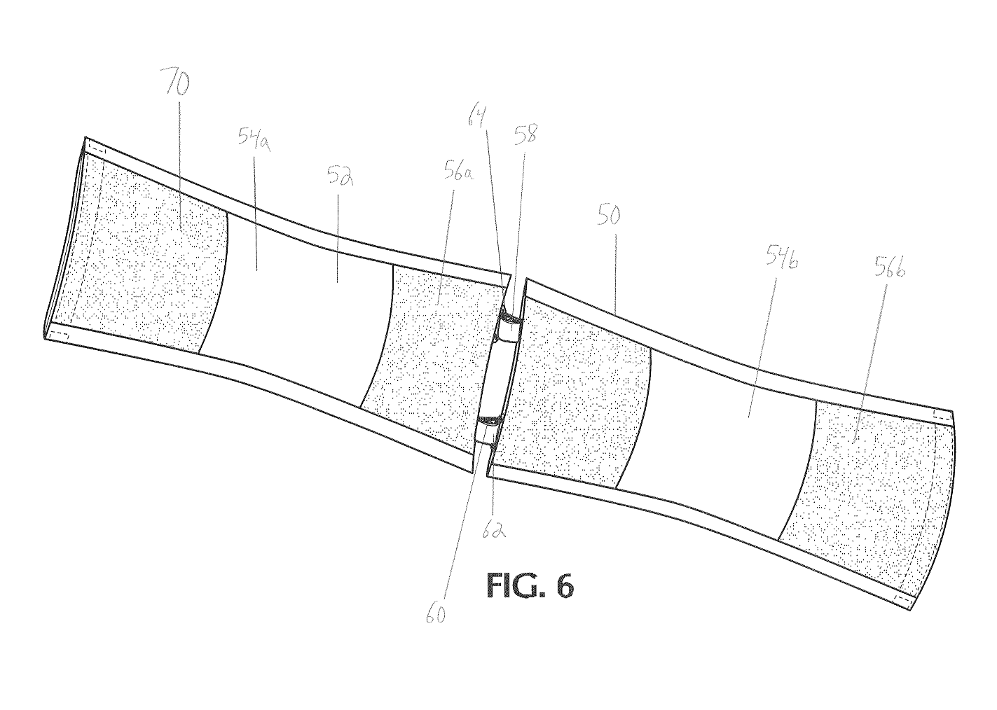

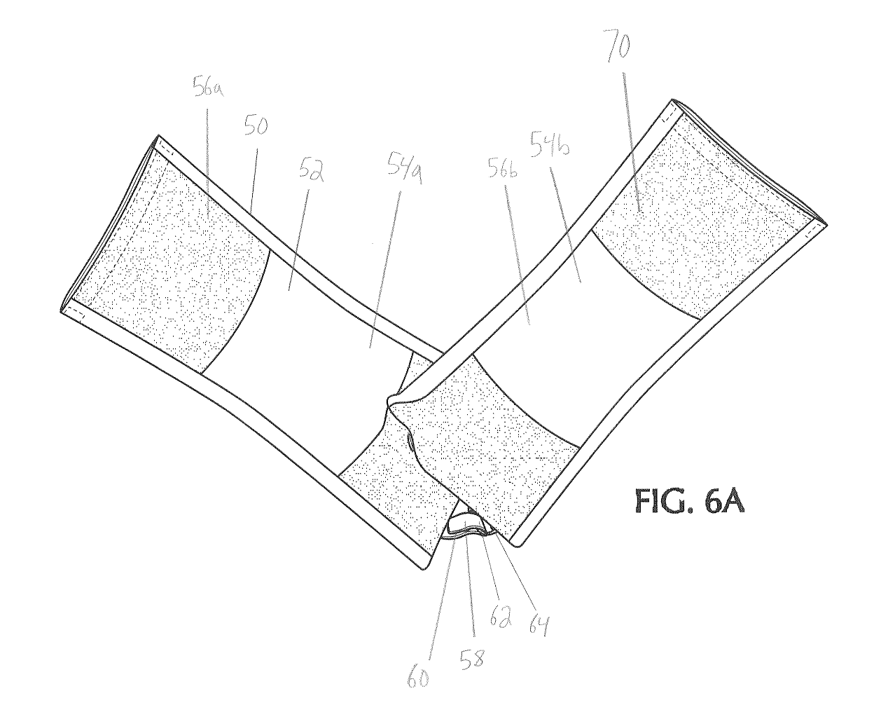

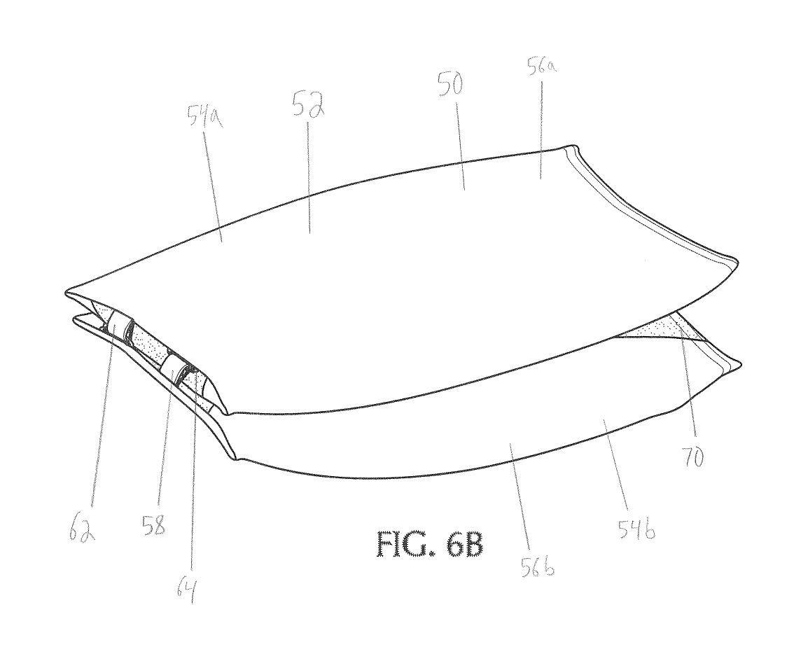

A further aspect of the invention is directed to an improved travel pillow 50. The improved travel pillow 50 includes inflatable cushioning 52 fabricated out of materials well known in the art, including plastic and fabric. In a preferred embodiment shown in FIG. 6, the inflatable cushioning 52 is comprised of a pair of inflatable pillows 54a, 54b, which are laterally spaced. The pillows 54a, 54b are preferably housed in separate, discrete covers 56a, 56b that have releasable sealing means as previously described. The pillow covers 56a, 56b have adjoining means 58 to connect the pillows to each other in an adjacent relationship. In the embodiment shown in FIG. 6, the adjoining means 58 comprise a series of snap fasteners 60 secured to straps 62 which are adapted to be received by loops 64 on the adjacent pillow. However, the adjoining means 58 may be any other releasable attachment method known in the art including hook and loop fasteners, ties, zippers, buttons, etc. When the snap fasteners 60 are engaged, the pillows 54a, 54b are firmly connected to each other but are adapted to allow the user to easily release the pillows from each other by disengaging the snap fasteners.

The pair of inflatable pillows 54a, 54b, which are connected by adjoining means 58 provides a highly adjustable travel pillow. The travel pillow is adapted so that the user can utilize one of the pair of inflatable pillows 54a, 54b as a pivoting point for the other pillow so that an optimal angle for the pillow with respect to the user's head can be achieved. As shown in FIG. 6a, the pillows 54a, 54b are pivoted with respect to each other while adjoined for enhanced comfort. Furthermore, as shown in 6b, the adjoined pillows 54a, 54b may be stacked on top of each other to form a thick pillow for enhanced comfort. The travel pillow is also adapted so that the user can inflate a first pillow a small amount and position the pillow behind their back and then inflate the second pillow and place the second pillow behind their head. The force of the user's back on the first pillow will help maintain the second pillow in place.

In another embodiment as shown in FIG. 4, the inflatable cushioning 52 comprises a pair of laterally spaced inflatable cushions 86, that are housed in a single cover 88. The cover 88 has releasable sealing means as previously described. The cover 88 preferably has a greater width than height and may be generally rectangular in shape. The cover is adapted to maintain the inflatable cushions 86 in a laterally spaced orientation. The cover 88 also protects the cushioning from being soiled and provides increased comfort. The travel pillow 50 may also include a top cushion which overlies the cushioning 52 so that the portion of the user's body contacting the travel pillow will rest against the top cushion for enhanced comfort.

In a preferred embodiment, the travel pillow 50 also has releasable attachment means which secure the travel pillow 50 to a seat back or other structure. In embodiments where the cushioning includes one or more covers 56a, 56b the attachment means may be attached directly to the covers. As shown in FIG. 5, the releasable attachment means are preferably straps. The straps may be integrally formed with the cushioning or covers or may be connected by means well known in the art including fasteners, stitching, etc. As an example, the cushioning may have covers with a pair of loops integral to the cover. The straps extend from the loops and are adapted to be secured to a connecting member on the seat back (such as the post of a headrest or a headrest cushion) or other structure. The straps may also be attached to another loop on the cushioning so that the strap forms a ring which can encircle the user's body in order to use the cushioning as a sling or otherwise. The ring formed by the strap attached to two loops on the cushioning may also be placed over a seat headrest or other structure to secure the travel pillow to the seat. In embodiments where the cushioning does not have a cover, the straps may be attached directly to the cushioning. The straps preferably have an anti-skid material to further stabilize the connection between the travel pillow and the seat back.

The travel pillow 50 has an anti-skid material 70 on a back-facing face of the cushioning 52 or cover(s) 56a, 56b which is in contact with a portion of the back of the seat. When the user places light pressure on the cushioning 52, the anti-skid material 70 is adapted to maintain the position of the cushioning on the seat back and resist further movement.

What is claimed is:

1. A wheelchair having a support comprising:
a frame;
a seat affixed to said frame, said seat having a bottom and back;
a pair of laterally spaced armrests;
a support attached to said armrests comprising a pair of laterally spaced inflatable pillows and attachment means for releasably securing the pillows to said armrests;
said support includes a back surface having an anti-skid material which contacts a portion of the back of the seat and maintains the support's position on the seat when light pressure is applied by a user's body resting against the support.

2. The wheelchair having a support in claim 1 wherein said pair of inflatable pillows includes adjoining means attaching said pillows to each other.

3. The wheelchair having a cushioned support in claim 1 wherein said attachment means is adapted to restrict further backward movement of the pillows after the user rests their body against the pillows in order to securely support the user's body in a fixed position.

4. The wheelchair having a support in claim 2 wherein:
each of said pair of inflatable pillows are enclosed in a discrete pillow cover having a front and back side;
said pillow covers include the adjoining means for connecting said discrete pillow covers to each other; and
the backs of said pillow covers have said anti-skid material.

5. The wheelchair having a support in claim 4 wherein each of said discrete pillow covers has releasable sealing means.

6. The wheelchair having a support in claim 1 wherein said pair of inflatable pillows are enclosed in a pillow cover having a front and back side;
said pillow cover is dimensioned to hold said inflatable pillows in an adjacent relationship to each other;
said pillow cover having attachment means securing said supportive member to said armrests, and the back of said pillow cover includes said anti-skid material.

7. The wheelchair having a support in claim 6 wherein said cover has releasable sealing means.

8. The wheelchair having a support in claim 1 wherein said attachment means comprises a plurality of adjustable straps attached to a periphery of each lateral side of said laterally spaced inflatable pillows or a cover therefor, said strap is adapted to releasably connect to the armrest on the same lateral side as the strap.

9. A wheelchair support comprising:
a pair of inflatable pillows spaced adjacent to each other;
said pillows having a back surface including an anti-skid material which contacts a portion of the back of the seat and maintains said pillows' position when light pressure is applied by a user's body resting against the pillows; and
attachment means adapted to releasably secure the pillows to armrests of a wheelchair;

10. The wheelchair support in claim 9 wherein said attachment means comprises a plurality of straps which extend from the pillows through openings beneath the wheelchair armrests to secure the pillows to said armrests.

11. The wheelchair support in claim 9 wherein said pair of inflatable pillows includes adjoining means attaching said pillows to each other.

12. The wheelchair support in claim 9 wherein said attachment means is adapted to restrict further backward movement of the pillows after the user rests their body against the pillows in order to securely support the user's body in a fixed position.

13. The wheelchair support in claim 9 wherein:
each of said pair of inflatable pillows are enclosed in a discrete pillow cover having a front and back side;
said pillow covers include the adjoining means for connecting said discrete pillow covers to each other; and
the backs of said pillow covers have said anti-skid material.

14. The wheelchair support in claim 13 wherein each of said discrete pillow covers have releasable sealing means.

15. The wheelchair support in claim 9 wherein said pair of inflatable pillows are enclosed in a pillow cover having a front and back side;
said pillow cover is dimensioned to hold said inflatable pillows in an adjacent relationship to each other;
said pillow cover having attachment means securing said supportive member to said armrests, and the back of said pillow cover includes said anti-skid material.

16. The wheelchair having a support in claim 9 wherein said attachment means comprises a plurality of adjustable straps attached to a periphery of each lateral side of said laterally spaced inflatable pillows or a cover therefor, said strap is adapted to releasably connect to the armrest on the same lateral side as the strap.

17. A travel pillow comprising:
a pair of inflatable pillows;
said inflatable pillows include adjoining means which attach said pillows to each other; and
said inflatable pillows include a back surface having an anti-skid material which maintains the pillows' position against a surface when light pressure is applied by a user's body on the pillows.

18. The travel pillow in claim 17, wherein
each of said pair of inflatable pillows are enclosed in a discrete pillow cover having a front and back side;
said pillow covers include the adjoining means for connecting said discrete pillow covers to each other; and
the backs of said pillow covers have said anti-skid material.

19. The travel pillow in claim 18 wherein the pillow covers have releasable sealing means.

20. The travel pillow in claim 17 wherein the travel pillow has attachment means to releasably secure the pillow to a seat back or other structure.

21. The travel pillow of claim 20 wherein said attachment means comprises at least one strap.

22. A travel pillow comprising a pair of inflatable pillows enclosed in a releasably sealed pillow cover, said pillow cover having a back surface including an anti-skid material which maintains said pillows' position on a surface when light pressure is applied by a user's body resting against the pillows.

23. The travel pillow in claim 22 wherein the travel pillow has attachment means to releasably secure the pillow to a seat back or other structure.

24. The travel pillow of claim 23 wherein said attachment means comprises at least one strap.
